(19) United States
(12) Patent Application Publication
(10) Pub. No.: US 2026/0006435 A1
(43) Pub. Date: Jan. 1, 2026

(54) METHODS AND SYSTEMS FOR MANAGING BEACONS

(71) Applicant: Cable Television Laboratories, Inc., Louisville, CO (US)

(72) Inventors: Zackary Foreman, Eugene, OR (US); John C. Bahr, Superior, CO (US); Stephen Arendt, Longmont, CO (US); Stephen G. Glennon, Lafayette, CO (US); Tucker Polomik, Longmont, CO (US)

(21) Appl. No.: 19/252,092

(22) Filed: Jun. 27, 2025

Related U.S. Application Data
(60) Provisional application No. 63/665,579, filed on Jun. 28, 2024.

(51) Int. Cl. H04W 12/037; H04W 48/12; H04W 84/12

(52) U.S. Cl. CPC H04W 12/037; H04W 48/12; H04W 84/12

(57) ABSTRACT

A method operable by a wireless access point for managing beacons in an Institute of Electrical and Electronics Engineers (IEEE) 802.11 wireless communication network includes (a) generating unencrypted first broadcast beacons, the unencrypted first broadcast beacons including a first Basic Service Set IDentifier (BSSID) identifying a first basic service set (BSS), (b) wirelessly transmitting the unencrypted first broadcast beacons to at least a first client of the IEEE 802.11 wireless communication network, (c) determining that the first client of the IEEE 802.11 wireless communication network has associated with the first BSS, (d) in response to determining that the first client of the IEEE 802.11 wireless communication network has associated with the first BSS, encrypting unencrypted first unicast beacons to obtain encrypted first unicast beacons, and (f) wirelessly transmitting the encrypted first unicast beacons to the first client of the IEEE 802.11 wireless communication network.

### RELATED APPLICATIONS

This application claims benefit of U.S. Provisional Patent Application No. 63/665,579, filed on Jun. 28, 2024, which is incorporated herein by reference.

### BACKGROUND

Beacons, which may also be referred to as beacon frames, are frames transmitted in an Institute of Electrical and Electronics Engineers (IEEE) 801.111 wireless communication network from a wireless access point to prospective and actual clients of the wireless communication network. Beacons perform several management functions in the wireless communication network. For example, beacons advertise the wireless communication network and provide information about the wireless communication network. As another example, beacons may support synchronization of devices, such as synchronization of wireless access points and clients, in the wireless communication network. Accordingly, beacons play an important role in IEEE 802.11 wireless communication network operation.

### SUMMARY

Disclosed herein are new methods and systems for managing beacons in an Institute of Electrical and Electronics Engineers (IEEE 802.11) wireless communication network which at least partially overcome limitations of conventional technology, at least partially by transmitting encrypted beacons, instead of unencrypted beacons, after association of a client to a Basic Service Set (BSS). For example, some embodiments of the new methods and systems (i) transmit unencrypted beacons in an IEEE 802.11 wireless communication network before a client of the IEEE 802.11 wireless communication network associates with a BSS and (ii) transmit encrypted beacons to the client after the client associates with the BSS.

In an embodiment, a method operable by a wireless access point for managing beacons in an IEEE 802.11 wireless communication network includes (1) generating unencrypted first broadcast beacons, the unencrypted first broadcast beacons including a first Basic Service Set IDentifier (BSSID) identifying a first basic service set BSS, (2) wirelessly transmitting the unencrypted first broadcast beacons to at least a first client of the IEEE 802.11 wireless communication network, (3) determining that the first client of the IEEE 802.11 wireless communication network has associated with the first BSS, (4) in response to determining that the first client of the IEEE 802.11 wireless communication network has associated with the first BSS, generating unencrypted first unicast beacons, (5) encrypting the unencrypted first unicast beacons to obtain encrypted first unicast beacons, and (6) wirelessly transmitting the encrypted first unicast beacons to the first client of the IEEE 802.11 wireless communication network.

In another embodiment, a method operable by a wireless access point for managing beacons in an IEEE 802.11 wireless communication network includes (1) generating unencrypted first broadcast beacons, the unencrypted first broadcast beacons including a first BSSID identifying a first BSS, (2) wirelessly transmitting the unencrypted first broadcast beacons to at least a first client of the IEEE 802.11 wireless communication network, (3) determining that the first client of the IEEE 802.11 wireless communication network has associated with the first BSS, (4) in response to determining that the first client of the IEEE 802.11 wireless communication network has associated with the first BSS, encrypting the unencrypted first broadcast beacons to obtain encrypted first broadcast beacons, and (5) wirelessly transmitting the encrypted first broadcast beacons to the first client of the IEEE 802.11 wireless communication network.

In an additional embodiment, a method operable by a wireless access point for managing beacons in an IEEE 802.11 wireless communication network includes (1) generating unencrypted first broadcast beacons, the unencrypted first broadcast beacons including a first BSSID identifying a first BSS, (2) wirelessly transmitting the unencrypted first broadcast beacons to at least a first set of a plurality of clients, (3) determining that each client of the first set of the plurality of clients has associated with the first BSS, (4) in response to determining that each client of the first set of the plurality of clients has associated with the first BSS, encrypting the unencrypted first broadcast beacons to obtain encrypted first broadcast beacons, and (5) wirelessly transmitting the encrypted first broadcast beacons to at least the first set of the plurality of clients.

### BRIEF DESCRIPTION OF THE DRAWINGS

FIG. 1 is a schematic diagram of a wireless communication environment including a system for managing beacons, according to an embodiment.

FIG. 2 is a data flow diagram illustrating an operating example of the FIG. 1 wireless communication environment where a wireless access point supports multiple Basic Service Sets (BSSs) and each BSS supports only one client, according to an embodiment.

FIG. 3 is a schematic diagram of the FIG. 1 wireless communication environment after conclusion of a first association process.

FIG. 4 is a schematic diagram of the FIG. 1 wireless communication environment after conclusion of a second association process.

FIG. 5 is an alternate embodiment of the FIG. 2 data flow diagram further including encrypted unicast beacons including a Channel Switch Announcement (CSA).

FIG. 6 is an alternate embodiment of the FIG. 2 data flow diagram where unicast beacons are replaced with broadcast beacons.

FIG. 7 is a schematic diagram of an alternate embodiment of the FIG. 1 wireless communication environment further including a client in the form of a smartwatch.

FIG. 8 is a data flow diagram illustrating an operating example of the FIG. 7 wireless communication environment where two clients are part of a common BSS.

FIG. 9 is a schematic diagram of the FIG. 7 wireless communication environment after conclusion of a second association process.

FIG. 10 is a flow chart of a method for managing beacons in an Institute of Electrical and Electronics Engineers (IEEE) 802.11 wireless communication network, according to an embodiment.

FIG. 11 is a flow chart of an additional method for managing beacons in an IEEE 802.11 wireless communication network, according to an embodiment.

FIG. 12 is a flow chart of a further method for managing beacons in an IEEE 802.11 wireless communication network, according to an embodiment.

### DETAILED DESCRIPTION OF THE EMBODIMENTS

There is great interest in securing Institute of Electrical and Electronics Engineers (IEEE) 802.11 wireless communication networks, such as to help ensure data integrity, data privacy, and network availability. Accordingly, the IEEE 802.11 standard has been supplemented by an amendment (IEEE 802.11w) that helps ensure security of many IEEE 802.11 management frames. However, while many management frames are relatively secure in an IEEE 802.11 wireless communication network, beacons are conventionally unencrypted in an IEEE 802.11 wireless communication network because beacon encryption is infeasible using conventional technology. In particular, beacons are used, in part, to advertise an available Basic Service Set (BSS) of an IEEE 802.11 wireless communication network to prospective clients of the IEEE 802.11 wireless communication network. Consequently, if the beacons were encrypted, an unassociated client would be unable to detect availability of a BSS and therefore would be unable to associate with the BSS.

Lack of beacon encryption in an IEEE 802.11 wireless communication network has significant downsides. For example, a wireless access point wanting to, or needing to, change its operating channel will transmit beacons including a Channel Switch Announcement (CSA), to advise recipient clients of an upcoming change in an operating channel of the wireless access point. The CSA includes a countdown field that signifies, when the count reaches zero, that the wireless access point will immediately change operating channels. A client receiving a beacon including a CSA will accordingly change its operating channel in response to the CSA. The fact that beacons are conventionally unencrypted enables a bad actor to exploit CSAs by transmitting rogue beacons including false CSAs that trick a client into changing its operating channel to a channel that is not being served by the client's host wireless access point, thereby disrupting wireless communication service to the client.

As another example, lack of beacon encryption may enable an attacker to impersonate a known IEEE 802.11 wireless communication network by broadcasting a spoofed Service set IDentifier (SSID) and similar BSS capabilities, potentially inducing a client to associate with a rogue AP, particularly in environments with overlapping or roaming-capable networks. While clients typically retain security settings for known SSIDs, insufficient validation of beacon authenticity may lead to unintended associations, degraded security guarantees, or susceptibility to man-in-the-middle attacks during roaming. Accordingly, there are significant downsides to transmission of unencrypted beacons in an IEEE 802.11 wireless communication network.

Disclosed herein are new methods and systems for managing beacons in an IEEE 802.11 wireless communication network which help overcome limitations of conventional technology at least partially by transmitting encrypted beacons, instead of unencrypted beacons, after association of a client to a BSS. For example, some embodiments of the new methods and systems (i) transmit unencrypted beacons in an IEEE 802.11 wireless communication network before a client of the IEEE 802.11 wireless communication network associates with a BSS and (ii) transmit encrypted beacons to the client after the client associates with the BSS. Transmission of unencrypted beacons before the client associates with the BSS enables the client to identify the BSS and to associate with the BSS. Transmission of encrypted beacons after the client associates with the BSS advantageously promotes wireless communication network security, such as by preventing unauthorized access to information within the beacons and/or by enabling a client to confirm provenance of the beacons. As such, the new methods and systems may at least partially overcome one or more of the drawbacks of conventional technology that are discussed above.

For example, use of encrypted beacons instead of unencrypted beacons may prevent a bad actor from tricking a client into changing its operating channel in response to false CSAs (i) by preventing the bad actor from obtaining information from legitimate beacons for use in generating rogue beacons with false CSAs and/or (ii) by enabling the client to distinguish between legitimate beacons and rogue beacons. As an additional example, use of encrypted beacons instead of unencrypted beacons helps prevent a rogue wireless access point from impersonating a legitimate wireless access point (i) by preventing a bad actor from obtaining information from legitimate beacons for use in impersonating a legitimate wireless access point and/or (ii) by facilitating a client in determining provenance of beacons and thereby distinguishing the rogue wireless access point from the legitimate wireless access point.

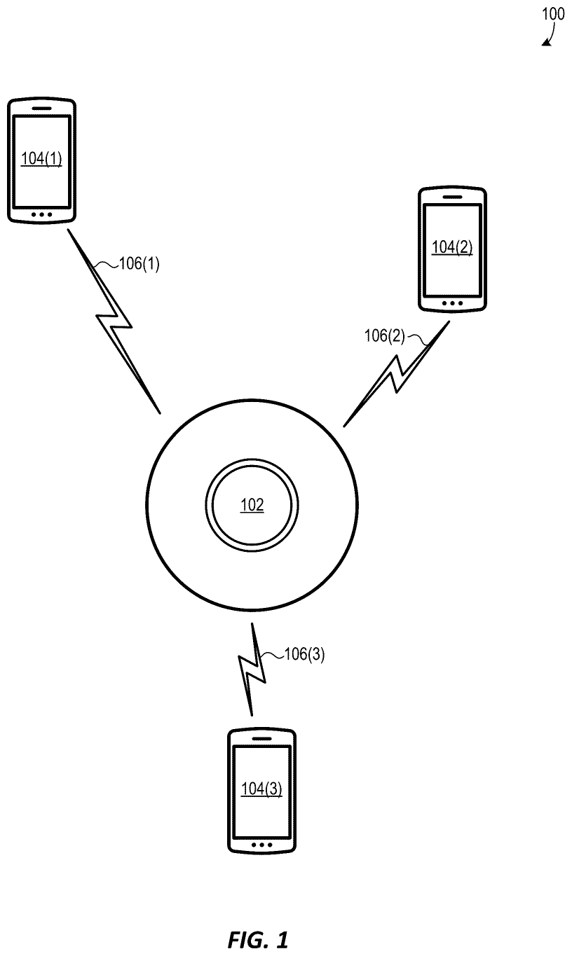

FIG. 1 is a schematic diagram of a wireless communication environment 100 including one embodiment of the new systems for managing beacons. Wireless communication environment 100 includes a wireless access point 102 and a plurality of clients 104. In this document, specific instances of an item may be referred to by use of a numeral in parentheses (e.g. client 104(1)) while numerals without parentheses refer to any such item (e.g. clients 104). Wireless communication environment 100 could be modified to include one or more additional wireless access points. For example, in some embodiments, wireless access point 102 is part of a collection of wireless access points collectively forming a mesh wireless communication network. Additionally, while wireless communication environment 100 is illustrated as including three clients 104, the quantity of clients 104 in wireless communication environment 100 may vary.

Wireless access point 102 is configured to wirelessly communicate with clients 104 via wireless communication signals 106, symbolically shown as lighting bolts in FIG. 1. Wireless access point 102 is configured to wirelessly communicate with clients 104 according to an IEEE 802.11 standard, such as a Wi-Fi wireless communication standard, or a successor thereof, and wireless access point 102 is there an IEEE 802.11 wireless access point. Each client 104 is configured to wirelessly communicate with wireless access point 102 according to an IEEE 802.11 standard, such as a Wi-Fi wireless communication standard, or a successor thereof. Although clients 104 are depicted as being mobile phones, clients 104 may take other forms, and each client 104 need not be the same type of client. For example, in some embodiments, one or more clients 104 is a computer, a set-top device, a data storage device, an Internet of Things (IoT) device, an entertainment device, a computer networking device, a smartwatch, a wearable device with wireless capability, a medical device, a security device, a monitoring device, and a wireless access device (including, for example, an IEEE 802.11 range extender, an IEEE 802.11 repeater, or another IEEE 802.11 wireless access point).

Wireless access point 102 is configured, for example, to communicatively interface clients 104 with a wide area network, such as an access network and/or the public Internet. Wireless access point 102 is formed, for example, of analog and/or digital electronic circuitry. Although wireless access point 102 is depicted as a standalone device, wireless access point 102 may be at least partially integrated with another device. For example, in some embodiments, wireless access point 102 is co-packaged with a modem or an optical network termination (ONT) as part of a premises gateway. Additionally, while wireless access point 102 is depicted as being a single element, wireless access point 102 may be formed of two or more sub-elements that need not be collocated. For example, in some embodiments, wireless access point 102 includes a radio sub-element and a control sub-element where these two sub-elements need not be collocated. For example, the radio sub-element could be located in the vicinity of clients 104 while the control sub-element could be implemented by a network controller that is remote from clients 104. While not required, particular embodiments of wireless access point 102 are configured to support multiple BSSs, such as virtual BSSs. For example, in some embodiments, wireless access point 102 is configured to support a respective BSS for each client 104. As another example, in certain embodiments, wireless access point 102 is configured to support a plurality of BSSs, where at least one of the plurality of BSSs may support two or more clients 104.

Wireless access point 102 is configured to implement particular embodiments of the new methods for managing beacons in an IEEE 802.11 wireless communication network. Accordingly, wireless access point 102 implements an embodiment of the new systems for managing beacons in an IEEE 802.11 wireless communication network. For example, in some embodiments where wireless access point 102 is configured such that each BSS supports only a single client 104, wireless access point 102 is configured to manage beacons for each supported BSS as follows: (i) wireless access point 102 generates and transmit unencrypted beacons associated with the BSS to clients 104 within wireless communication range of wireless access point 102 before any client 104 has associated with the BSS, and (ii) once a client 104 has associated with the BSS, wireless access point 102 generates and transmits encrypted beacons to the client associated with the BSS. As another example, in certain embodiments where wireless access point 102 is configured such that each BSS supports two or more clients 104, wireless access point 102 is configured to manage beacons for each supported BSS as follows: (i) wireless access point 102 generates and transmit unencrypted beacons associated with the BSS to clients 104 within wireless communication range of wireless access point 102 before any client 104 has associated with the BSS, and (ii) once all clients 104 that are authorized to access the BSS have associated with the BSS, wireless access point 102 generates and transmits encrypted beacons to all clients associated with the BSS.

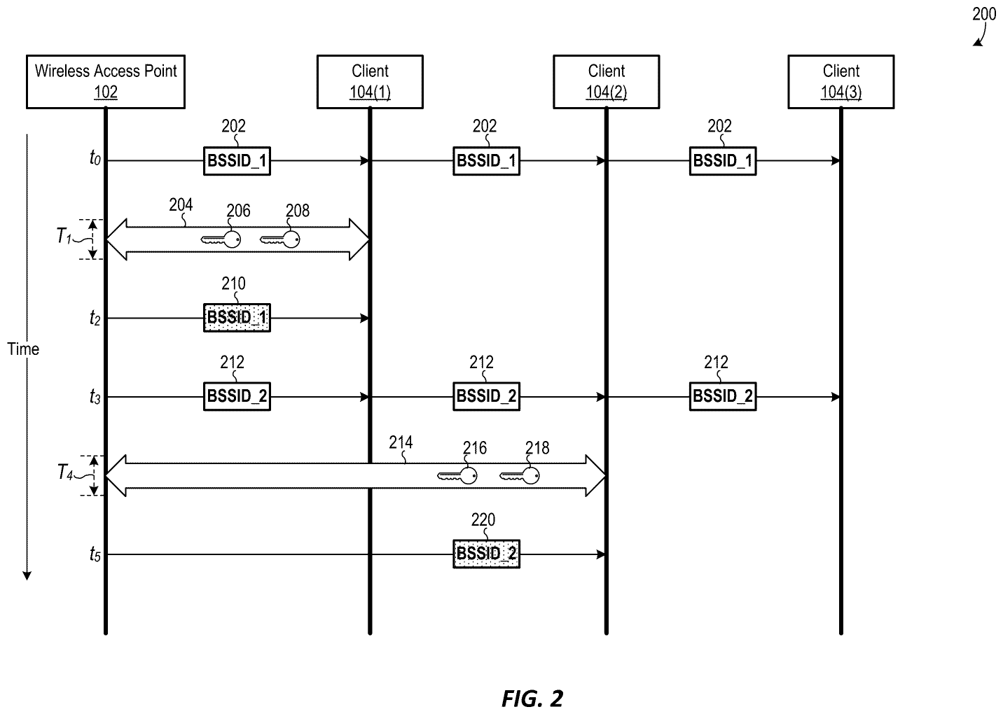

Discussed below with respect to FIGS. 2-12 are several examples of operation of wireless communication environment 100. However, it is understood that wireless communication environment 100 is not limited to operating according to the examples of FIGS. 2-12. Additionally, the examples of FIGS. 2-12 could be implemented in communication environments other than wireless communication environment 100.

FIG. 2 is a data flow diagram 200 illustrating an example of operation of wireless communication environment 100 where (i) wireless access point 102 supports multiple BSSs and (ii) each BSS is limited to supporting one respective client 104. Data flow diagram 200 includes vertical lines logically representing each of wireless access point 102, client 104(1), client 104(2), and client 104(3). Data flow diagram 200 assumes that no clients 104 have associated with any BSS supported by wireless access point 102 at the beginning of the example operating method of FIG. 2. At a time t₀, wireless access point 102 generates unencrypted broadcast beacons 202, and wireless access point 102 wirelessly transmits unencrypted broadcast beacons 202 to each client 104 within wireless communication range of wireless access point 102. Accordingly, each client 104 of wireless communication environment 100 receives unencrypted broadcast beacons 202, as illustrated in FIG. 2. Each unencrypted broadcast beacon 202 includes a Basic Service Set IDentifier BSSID_1, which identifies a Basic Service Set BSS_1 supported by wireless access point 102.

Client 104(1) elects to associate with Basic Service Set BSS_1 in response to receipt of unencrypted broadcast beacons 202. Accordingly, client 104(1) associates with Basic Service Set BSS_1 during a time period T₁ after time t₀ via an association process 204. Association process 204 includes, for example, an IEEE 802.11 4-way handshake process where wireless access point 102 and client 104(1) exchange messages to establish a secure connection between client 104(1) and wireless access point 102, where the messages include keys exchanged between client 104(1) and wireless access point 102. The keys exchanged during association process 204 include, for example, a pairwise transient key (PTK) 206 and an optional group temporal key (GTK) 208. PTK 206 is associated with client 104(1), and PTK is used to encrypt data transmitted between client 104(1) and wireless access point 102. GTK 208 is used to encrypt broadcast and multicast traffic (if any) in Basic Service Set BSS_1. Wireless access point 102 determines that client 104(1) is associated with Basic Service Set BSS_1 at the conclusion of association process 204, and in response thereto, wireless access point 102 (i) generates unicast beacons 210, (ii) encrypts unicast beacons 210, such as using PTK 206, and (iii) wireless transmits encrypted unicast beacons 210 to client 104(1), at a time t₂. Encryption of beacons in the present figures is symbolically shown by shading of the beacons.

It should be noted that client 104(1) is able to decrypt unicast beacons 210 using a key exchanged with wireless access point 102 during association process 204. For example, in embodiments where wireless access point 102 encrypts unicast beacons 210 using PTK 206, client 104(1) can decrypt unicast beacons 210 using PTK 206. However, any other client 104 is unable to decrypt unicast beacons 210 because only client 104(1) possesses the necessary key to decrypt unicast beacons 210. Accordingly, encryption of unicast beacons 210 promotes privacy and integrity of data exchanged between client 104(1) and wireless access point 102 via wireless communication signals 106(1), as well a resistance to malicious interruption of communication between client 104(1) and wireless access point 102, such as by preventing a third party from accessing contents of unicast beacons 210 and/or by enabling client 104(1) to confirm that unicast beacons 210 originated from wireless access point 102.

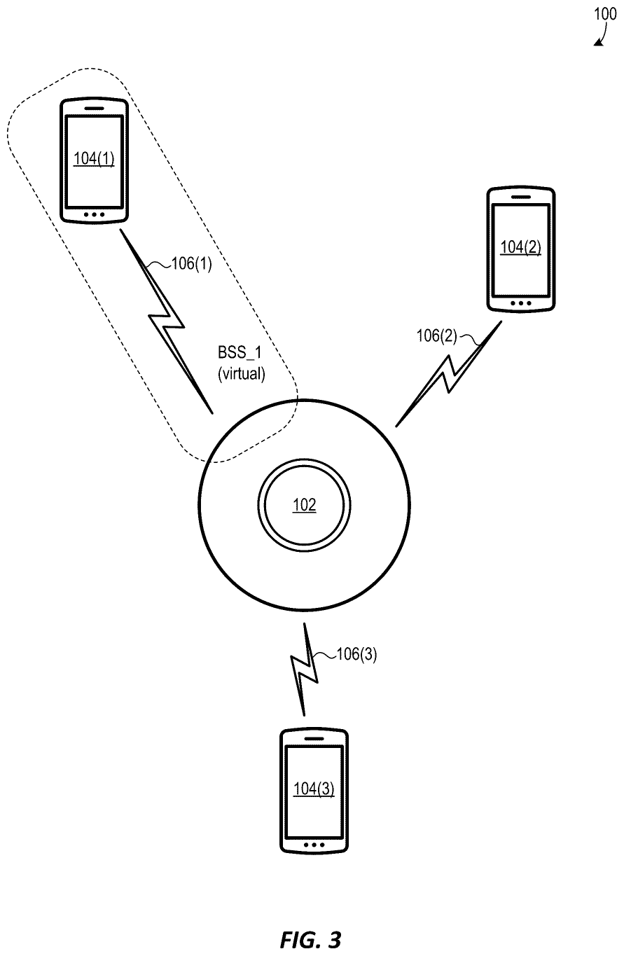

FIG. 3 is a schematic diagram of wireless communication environment 100 after conclusion of association process 204 of FIG. 2. As illustrated in FIG. 3, client 104(1) is part of Basic Service Set BSS_1 including client 104(1) and wireless access point 102. Basic Service Set BSS_1 is, for example, a virtual Basic Service Set, as illustrated in FIG. 3. Consequently, client 104(1) is logically isolated from other clients 104 being served by wireless access point 102, thereby further promoting secure operation of wireless communication environment 100.

Referring again to FIG. 2, at a time t₃, wireless access point 102 generates unencrypted broadcast beacons 212, and wireless access point 102 wirelessly transmits unencrypted broadcast beacons 212 to each client 104 within wireless communication range of wireless access point 102. Accordingly, each client 104 of wireless communication environment 100 receives unencrypted broadcast beacons 212, as illustrated in FIG. 2. Each unencrypted broadcast beacon 212 includes a Basic Service Set IDentifier BSSID 2, which identifies a Basic Service Set BSS_2 supported by wireless access point 102. Client 104(2) elects to associate with Basic Service Set BSS_2 in response to receipt of unencrypted broadcast beacons 212, and client 104(2) therefore associates with Basic Service Set BSS_2 during a time period T₄ after time t₃ via an association process 214. Association process 214 is analogous to association process 204 and includes, for example, an IEEE 802.11 4-way handshake process where wireless access point 102 and client 104(2) exchange messages to establish a secure connection between client 104(2) and wireless access point 102, where the messages include one or more keys. Keys exchanged during association process 214 include, for example, a PTK 216 and an optional GTK 218. PTK 216 is associated with client 104(2), and PTK 216 is different from PTK 206 associated with client 104(1). PTK 216 is used to encrypt data transmitted by between client 104(2) and wireless access point 102. GTK 218 is used to encrypt broadcast and multicast traffic (if any) in Basic Service Set BSS 2.

Wireless access point 102 determines that client 104(2) is associated with Basic Service Set BSS_2 at the conclusion of association process 214, and in response thereto, wireless access point 102 (i) generates unicast beacons 220, (ii) encrypts unicast beacons 220, such as using PTK 216, and (iii) wireless transmits encrypted unicast beacons 220 to client 104(1), at a time t₅. Client 104(2) is able to decrypt encrypted unicast beacons 220 using a key exchanged with wireless access point 102 during association process 214. For example, in embodiments where wireless access point 102 encrypts unicast beacons 220 using PTK 216, client 104(2) can decrypt encrypted unicast beacons 220 using PTK 216. However, any other client 104, e.g., client 104(1), is unable to decrypt encrypted unicast beacons 220 because only client 104(2) possesses the necessary key to decrypt encrypted unicast beacons 220. The operating example of dataflow diagram 200 could be extended to include association of additional clients 104 with respective additional BSSs supported by wireless access point 102 and transmission of respective encrypted unicast beacons for each additional BSS.

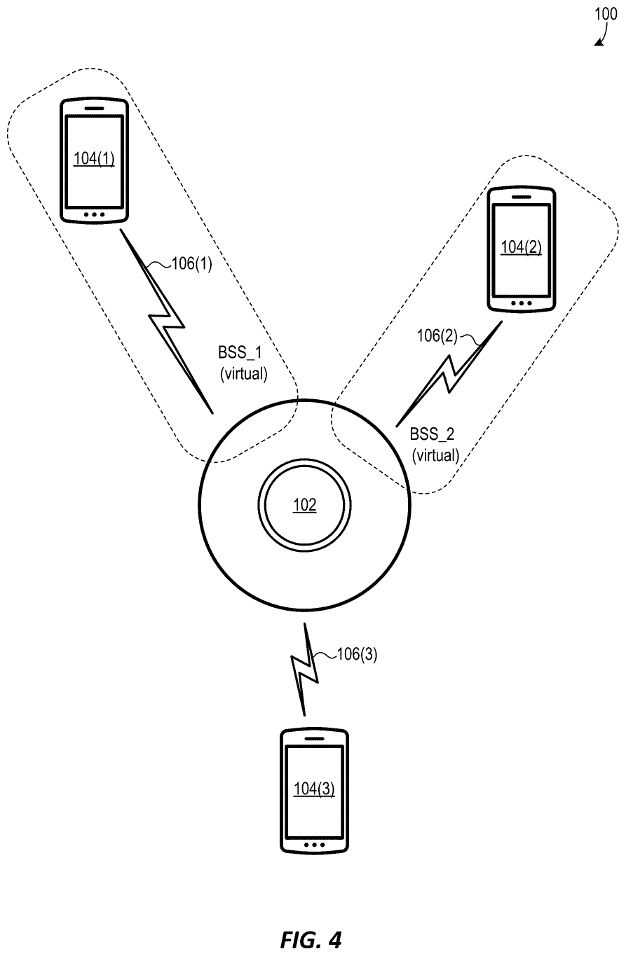

FIG. 4 is a schematic diagram of wireless communication environment 100 after conclusion of association process 214 of FIG. 2. As illustrated in FIG. 4, client 104(2) is part of Basic Service Set BSS_2 including client 104(2) and wireless access point 102. Basic Service Set BSS_2 is, for example, a virtual Basic Service Set. Additionally, client 104(1) remains part of Basic Service Set BSS_1, and clients 104(1) and 104(2) are accordingly logically isolated from each other in wireless communication environment 100.

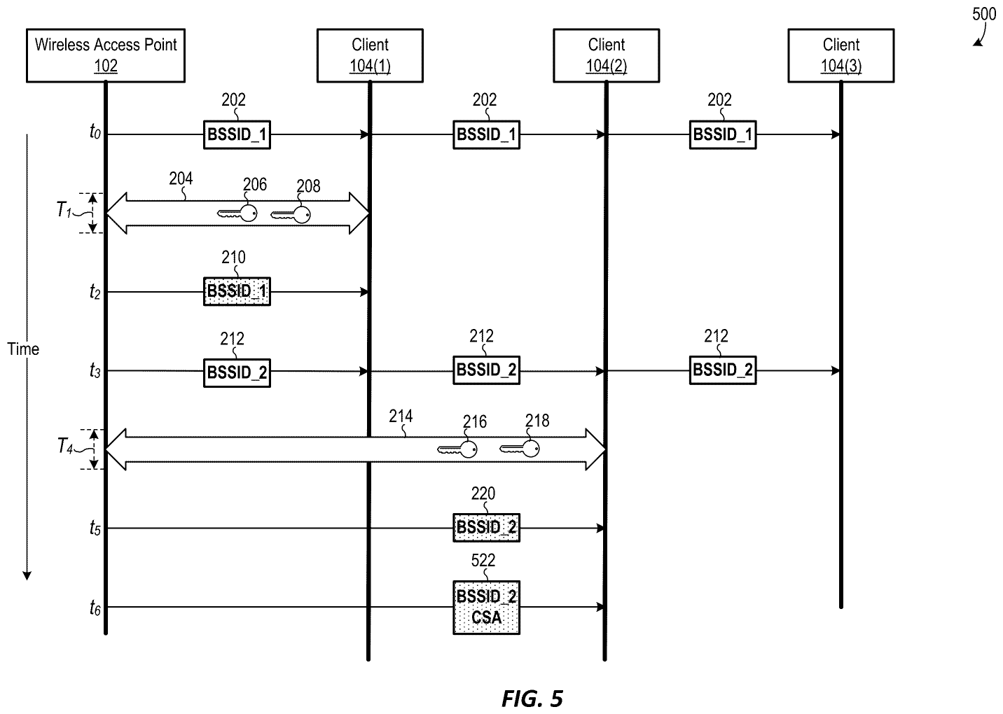

FIG. 5 is a data flow diagram 500 illustrating another example of operation of wireless communication environment 100 where (i) wireless access point 102 supports multiple BSSs and (ii) each BSS supports only one client 104. The example of operation of FIG. 5 is like the example of operation of FIG. 2 except that the FIG. 5 example further includes, at a time t₆, wireless access point 102 (i) generating unicast beacons 522, (ii) encrypting unicast beacons 522, such as using PTK 216, and (iii) wirelessly transmitting encrypted unicast beacons 522 to client 104(2). Encrypted unicast beacons 522 further include a CSA, as illustrated in FIG. 5. The fact that unicast beacons 522 are encrypted enables particular embodiments of client 104(2) to confirm that unicast beacons 522 originated from wireless access point 102, thereby enabling client 104(2) to determine that it is safe to act on the CAS included in encrypted unicast beacons 522.

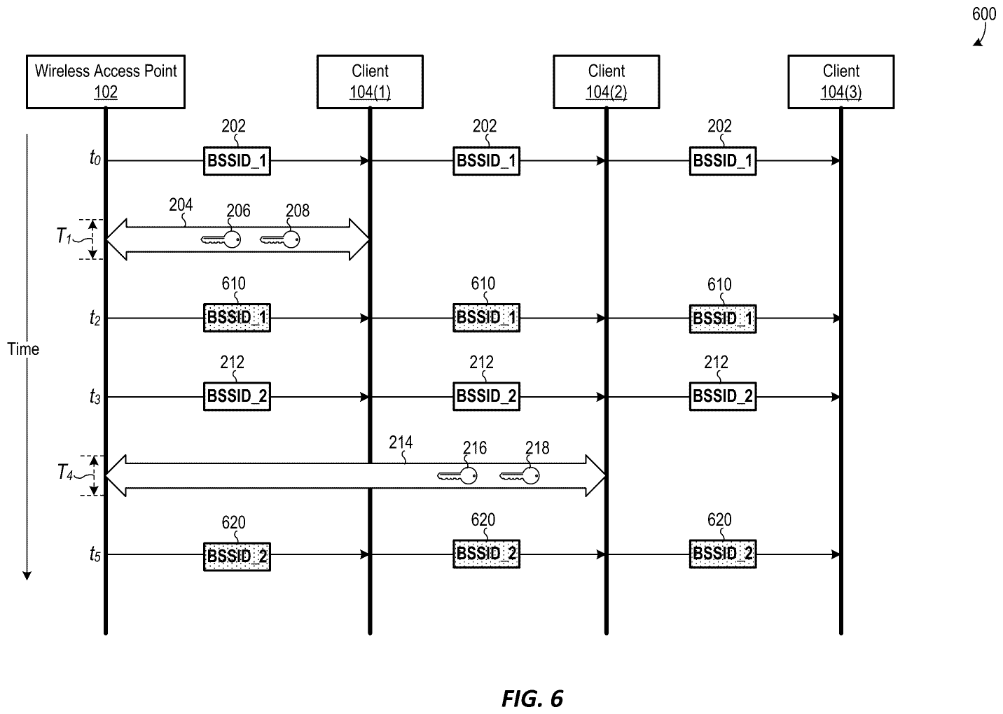

FIG. 6 is a data flow diagram 600 which is an alternate embodiment of data flow diagram 200 (FIG. 2) where encrypted unicast beacons are replaced with encrypted broadcast beacons. Data flow diagram 600 differs from data flow diagram 200 in actions performed by wireless access point 102 times t₂ and t₅. In particular, at time t₂, wireless access point 102 determines that client 104(1) has associated with Basic Service Set BSS_1, and in response thereto, wireless access point 102 (i) encrypts broadcast beacons 202, such as using PTK 206, to obtain encrypted broadcast beacons 610, and (iii) wirelessly transmits encrypted broadcast beacons 610 to clients 104 within radio frequency range of wireless access point 102. Consequently, all clients 104 receive encrypted broadcast beacons 610, as illustrated in FIG. 6. However, only client 104(1) possesses the necessary key, e.g., PTK 206, to decrypt encrypted broadcast beacons 610. As such, client 104(1) is the only client 104 of wireless communication environment 100 that can process encrypted broadcast beacons 610, and encrypted broadcast beacons 610 therefore effectively operate as unicast beacons directed to client 104(1).

Similarly, at time t₅, wireless access point 102 determines that client 104(2) has associated with Basic Service Set BSS_2, and in response thereto, wireless access point 102 (i) encrypts broadcast beacons 212, such as using PTK 216, to obtain encrypted broadcast beacons 620, and (iii) wirelessly transmits encrypted broadcast beacons 620 to clients 104 within radio frequency range of wireless access point 102. Consequently, all clients 104 receive encrypted broadcast beacons 620, although only client 104(2) possesses the necessary key, e.g., PTK 216, to decrypt encrypted broadcast beacons 620.

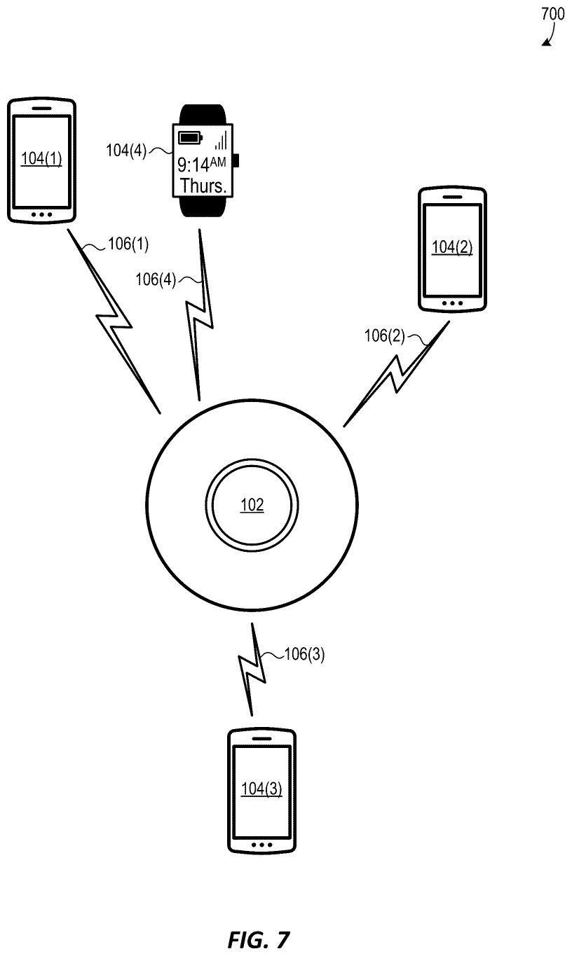

FIG. 7 is a schematic diagram of a wireless communication environment 700, which is an alternate embodiment of wireless communication environment 100 (FIG. 1) including an additional client 104(4) in the form of a smartwatch. Wireless access point 102 is configured to wirelessly communicate with client 104(4) via wireless communication signals 106(4) according to an IEEE 802.11 wireless communication standard. Client 104(1) and client 104(4) are owned by a common user in this embodiment, and it is therefore desirable that client 104(1) and 104(4) be part of a common BSS, such as to enable the two clients to communicate with each other via wireless access point 102. Accordingly, particular embodiments of wireless access point 102 are configured to transmit encrypted beacons of a common BSS to each of client 104(1) and client 104(4) after both of these clients have associated with the common BSS.

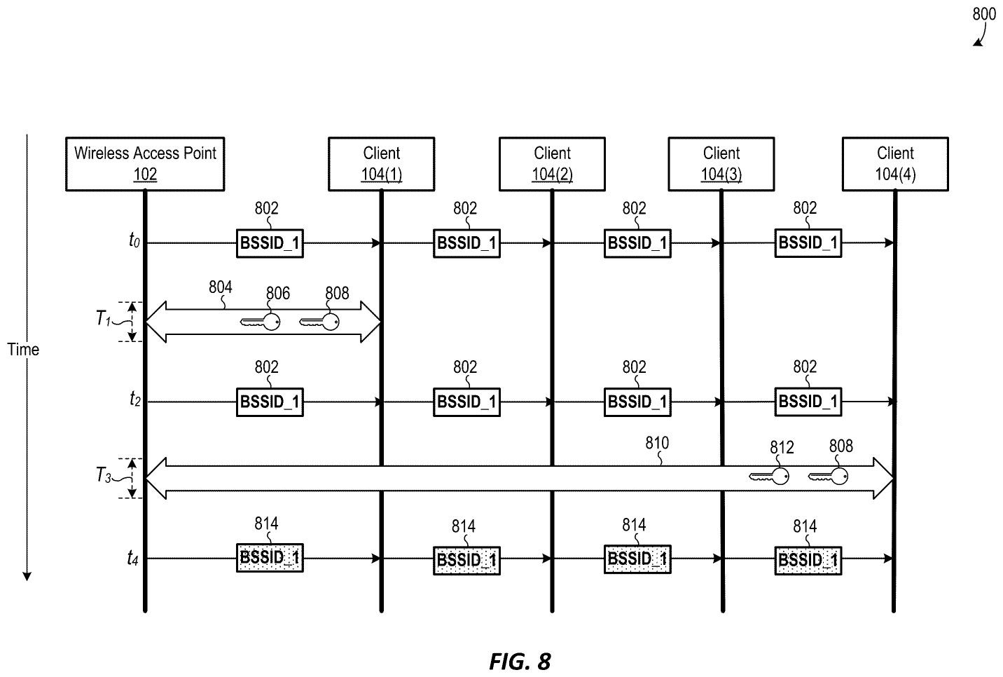

For example, FIG. 8 is a data flow diagram 800 illustrating an example of operation of wireless communication environment 700 where (i) wireless access point 102 supports multiple BSSs and (ii) and one particular BSS is configured to support each of client 104(1) and 104(4). Data flow diagram 800 includes vertical lines logically representing each of wireless access point 102, client 104(1), client 104(2), client 104(3), and client 104(4). Data flow diagram 800 assumes that no clients 104 have associated with any BSS supported by wireless access point 102 at the beginning of the example operating method illustrated in FIG. 8. At a time t₀, wireless access point 102 generates unencrypted broadcast beacons 802, and wireless access point 102 wirelessly transmits unencrypted broadcast beacons 802 to each client 104 within wireless communication range of wireless access point 102. Accordingly, each client 104 of wireless communication environment 100 receives unencrypted broadcast beacons 802, as illustrated in FIG. 8. Each unencrypted broadcast beacon 802 includes a Basic Service Set IDentifier BSSID_1, which identifies a Basic Service Set BSS_1 supported by wireless access point 102.

Client 104(1) elects to associate with Basic Service Set BSS_1 in response to receipt of unencrypted broadcast beacons 802. Accordingly, client 104(1) associates with Basic Service Set BSS_1 during a time period T₁ after time t₀ via an association process 804. Association process 804 includes, for example, an IEEE 802.11 4-way handshake process where wireless access point 102 and client 104(1) exchange messages to establish a secure connection between client 104(1) and wireless access point 102, where the messages include keys exchanged between client 104(1) and wireless access point 102. The keys exchanged during association process 804 include, for example, a PTK 806 and a GTK 808.

Wireless access point 102 determines that client 104(1) is associated with Basic Service Set BSS 1 at the conclusion of association process 804. However, client 104(4), which is also intended to be associated with Basic Service Set BSS_1, is not yet associated with the Basic Service Set. As such, client 104(4) would not be able to associate with Basic Service Set BSS 1 if wireless access point 102 were to transmit encrypted beacons associated with Basic Service Set BSS_1 at the conclusion of association process 804. Therefore, at a time t₂, wireless access point 102 again wirelessly transmits unencrypted broadcast beacons 802 to each client 104 within wireless communication range of wireless access point 102. Client 104(4) subsequently elects to associate with Basic Service Set BSS_1 in response to receipt of unencrypted broadcast beacons 802 at time t₂. Accordingly, client 104(4) associates with Basic Service Set BSS_1 during a time period T₃ after time t₂ via an association process 810. Association process 810 includes, for example, an IEEE 802.11 4-way handshake process where wireless access point 102 and client 104(4) exchange messages to establish a secure connection between client 104(4) and wireless access point 102, where the messages include keys exchanged between client 104(4) and wireless access point 102. The keys exchanged during association process 804 include, for example, a PTK 812 and GTK 808. It should be noted that the same GTK, i.e., GTK 808, is exchanged in each of association process 804 and association process 810, and client 104(1) and client 104(4) therefore share a common GTK.

Wireless access point 102 determines that each of client 104(1) and client 104(4) is associated with Basic Service Set BSS_1 at the conclusion of association process 810. As such, there is no longer a need to transmit unencrypted beacons associated with Basic Service Set BSS 1 because all intended clients of Basic Service Set BSS 1 have now associated with the Basic Service Set. Therefore, at a time t₄, wireless access point 102 (i) encrypts broadcast beacons 802, such as using GTK 808 to enable of clients 104(1) and 104(4) to decrypt encrypted broadcast beacons 814, and (ii) wirelessly transmits encrypted broadcast beacons 814 to each client 104 within wireless communication range of wireless access point 102. Although all clients 104 receive encrypted broadcast beacons 814, only clients 104(1) and 104(4) possess the necessary key, e.g., GTK 808, to decrypt encrypted broadcast beacons 814, and encrypted broadcast beacons 814 therefore effectively operate as beacons dedicated solely to clients 104(1) and 104(4).

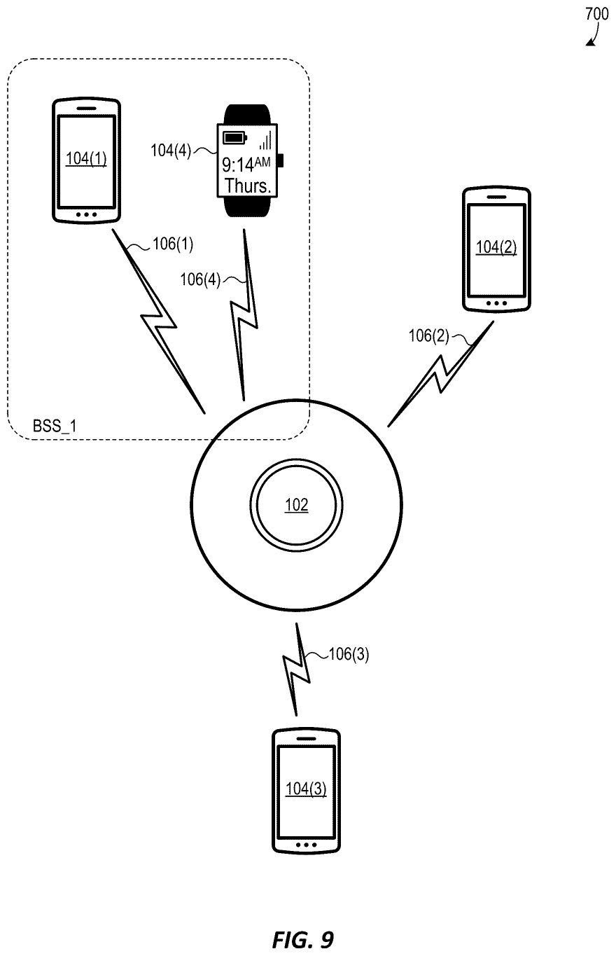

FIG. 9 is a schematic diagram of wireless communication environment 700 after conclusion of association process 810 of FIG. 8. As illustrated in FIG. 9, each of client 104(1) and client 104(4) is part of Basic Service Set BSS_1 including these two clients and wireless access point 102. Consequently, client 104(1) and client 104(4) can communicate with each other via Basic Service Set BSS_1.

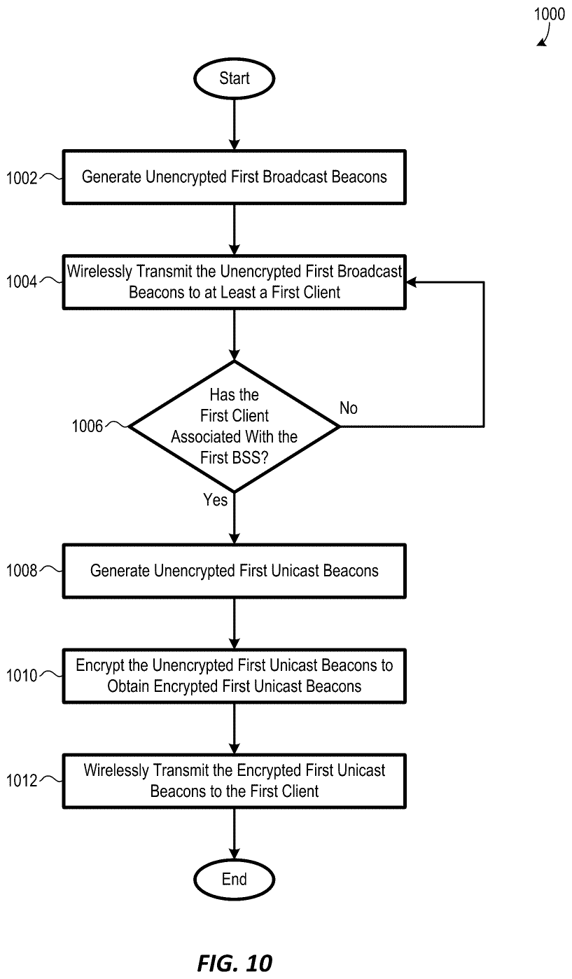

FIG. 10 is a flow chart of a method 1000 for managing beacons in an IEEE 802.11 wireless communication network, which is another example of operation of wireless communication environment 100. In a block 1002 of method 1000, wireless access point 102 generates unencrypted first broadcast beacons including a first BSSID identifying a first BSS. Method 1000 proceeds from block 1002 to a block 1004 where wireless access point 102 transmits the unencrypted first broadcast beacons to at least a first client. In one example of blocks 1002 and 1004, wireless access point 102 generates unencrypted broadcast beacons 202 including Basic Service Set IDentifier BSSID_1 representing Basic Service Set BSS_1, and wireless access point 102 transmits unencrypted broadcast beacons 202 to each client 104, as illustrated in FIG. 2. Method 1000 proceeds from block 1004 to a decision block 1006 where wireless access point 102 determines whether the first client has associated with the first BSS. If the result of decision block 1006 is no, method 1000 determines that the first client has not associated with the first BSS, and method 1000 returns to block 1004 where wireless access point 102 continues to transmit unencrypted first broadcast beacons. If the result of decision block 1006 is yes, method 1000 determines that the first client has associated with the first BSS, and in response thereto, method 1000 proceeds to a block 1008 of method 1000. In one example of decision block 1006, wireless access point 102 determines at the conclusion of association process 204 (FIG. 2) that client 104(1) has associated with Basic Service Set BSS 1.

In block 1008, wireless access point 102 generates unencrypted first unicast beacons. Method 1000 proceeds from block 1008 to a block 1010 where wireless access point 102 encrypts the unencrypted first unicast beacons generated in block 1008 to obtain encrypted first unicast beacons. Method 1000 then proceed from block 1010 to a block 1012 where wireless access point 102 transmits the encrypted first unicast beacons to the first client. In one example of blocks 1008, 1010, and 1012, wireless access point 102 generates unicast beacons 220, encrypts unicast beacons 220, and transmits encrypted unicast beacons 220 to client 104(1), as illustrated in FIG. 2.

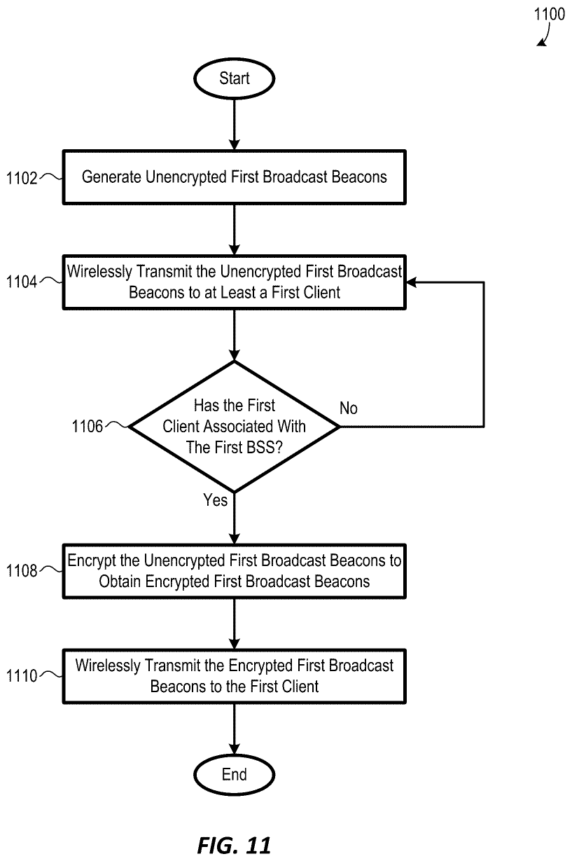

FIG. 11 is a flow chart of a method 1100 for managing beacons in an IEEE 802.11 wireless communication network, which is an additional example of operation of wireless communication environment 100. In a block 1102 of method 1100, wireless access point 102 generates unencrypted first broadcast beacons including a first BSSID identifying a first BSS. Method 1100 proceeds from block 1102 to a block 1104 where wireless access point 102 transmits the unencrypted first broadcast beacons to at least a first client. In one example of blocks 1102 and 1104, wireless access point 102 generates unencrypted broadcast beacons 202 including Basic Service Set IDentifier BSSID_1 representing Basic Service Set BSS_1, and wireless access point 102 transmits unencrypted broadcast beacons 202 to each client 104, as illustrated in FIG. 6. Method 1100 proceeds from block 1104 to a decision block 1106 where wireless access point 102 determines whether the first client has associated with the first BSS. If the result of decision block 1106 is no, method 1100 determines the first client has not associated with the first BSS, and method 1100 returns to block 1104 where wireless access point 102 continues to wirelessly transmit unencrypted first broadcast beacons. If the result of decision block 1106 is yes, method 1100 determines that the first client has associated with the first BSS, and in response thereto, method 1100 proceeds to a block 1108 of method 1100. In one example of decision block 1106, wireless access point 102 determines at the conclusion of association process 204 (FIG. 6) that client 104(1) has associated with Basic Service Set BSS_1. In block 1108, wireless access point 102 encrypts the unencrypted first broadcast beacons to obtain encrypted first unicast beacons. Method 1100 then proceeds from block 1108 to a block 1110 where wireless access point 102 transmits the encrypted first broadcast beacons to the first client. In one example of blocks 1108 and 1110, and 1012, wireless access point 102 encrypts broadcast beacons 202 to obtain encrypted broadcast beacons 610, and wireless access point 102 transmits encrypted broadcast beacons 610 to each client 104, as illustrated in FIG. 6.

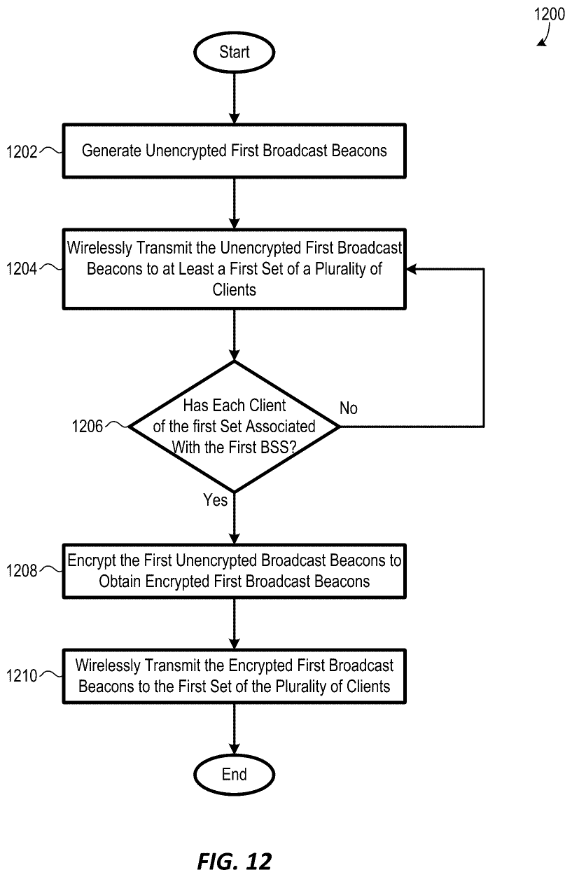

FIG. 12 is a flow chart of a method 1200 for managing beacons in an IEEE 802.11 wireless communication network, which is a further example of operation of wireless communication environment 100. In a block 1202 of method 1200, wireless access point 102 generates unencrypted first broadcast beacons including a first BSSID identifying a first BSS. Method 1200 proceeds from block 1202 to a block 2104 where wireless access point 102 transmits the unencrypted first broadcast beacons to at least a first set of a plurality of clients. In one example of blocks 1202 and 1204, wireless access point 102 generates unencrypted broadcast beacons 802, and wireless access point 102 wirelessly transmits unencrypted broadcast beacons 802 to each client 104 within wireless communication range of wireless access point 102, as illustrated in FIG. 8. Method 1200 proceeds from block 1204 to a decision block 1206 where wireless access point 102 determines whether each client of the first set of the plurality of clients has associated with the first BSS. If the result of decision block 1206 is no, method 1200 determines the clients of the first set have not associated with the first BSS, and method 1200 returns to block 1204 where wireless access point 102 continues to wirelessly transmit unencrypted first broadcast beacons. If the result of decision block 1206 is yes, method 1200 determines that each client of the first set has associated with the first BSS, and in response thereto, method 1200 proceeds to a block 1208 of method 1200. In one example of decision block 1206, wireless access point 102 determines at the conclusion of association process 804 that only client 104(1) of a set of clients consisting of clients 104(1) and 104(4) has associated with Basic Service Set BSS_1, and in response thereto, method 1200 returns to block 1204. In another example of decision block 1206, wireless access point 102 determines at the conclusion of association process 810 that both of clients 104(1) and 104(4) of the set of clients consisting of clients 104(1) and 104(4) has associated with Basic Service Set BSS_1, and in response thereto, method 1200 proceeds to block 1208.

In block 1208, wireless access point 102 encrypts the unencrypted first broadcast beacons to obtain encrypted first broadcast beacons. Method 1200 then proceeds from block 1208 to a block 1210 where wireless access point 102 wirelessly transmits the encrypted first broadcast beacons to at least the first set of the plurality of clients. In one example of blocks 1208 and 1210, wireless access point 102 encrypts broadcast beacons 802 to obtain encrypted broadcast beacons 814, and wireless access point 102 wirelessly transmits encrypted broadcast beacons 814 to each client 104, as illustrated in FIG. 8.

### Combinations of Features

Features described above may be combined in various ways without departing from the scope hereof. The following examples illustrate some possible combinations
(A1) A method operable by a wireless access point for managing beacons in an Institute of Electrical and Electronics Engineers (IEEE) 802.11 wireless communication network includes (1) generating unencrypted first broadcast beacons, the unencrypted first broadcast beacons including a first Basic Service Set IDentifier (BSSID) identifying a first basic service set (BSS), (2) wirelessly transmitting the unencrypted first broadcast beacons to at least a first client of the IEEE 802.11 wireless communication network, (3) determining that the first client of the IEEE 802.11 wireless communication network has associated with the first BSS, (4) in response to determining that the first client of the IEEE 802.11 wireless communication network has associated with the first BSS, generating unencrypted first unicast beacons, (5) encrypting the unencrypted first unicast beacons to obtain encrypted first unicast beacons, and (6) wirelessly transmitting the encrypted first unicast beacons to the first client of the IEEE 802.11 wireless communication network.
(A2) In the method denoted as (A1), encrypting the unencrypted first unicast beacons to obtain encrypted first unicast beacons may include encrypting the unencrypted first unicast beacons using a pairwise transient key (PTK) associated with the first client of the IEEE 802.11 wireless communication network.
(A3) Either one of the methods denoted as (A1) and (A2) may further include exchanging a key with the first client of the IEEE 802.11 wireless communication network to enable the first client of the IEEE 802.11 wireless communication network to decrypt the encrypted first unicast beacons.
(A4) In any one of the methods denoted as (A1) through (A3), a second client of the IEEE 802.11 wireless communication network may be unable to decrypt the encrypted first unicast beacons.
(A5) In any one of the methods denoted as (A1) through (A4), the encrypted first unicast beacons may include the first BSSID.
(A6) In any one of the methods denoted as (A1) through (A5), at least one of the encrypted first unicast beacons may include a channel switch announcement.
(A7) In any one of the methods denoted as (A1) through (A6), the first BSS may be a virtual BSS.
(A8) The method denoted as (A1) may further include (1) determining that a second client of the IEEE 802.11 wireless communication network has associated with a second BSS, (2) in response to determining that the second client of the IEEE 802.11 wireless communication network has associated with the second BSS, generating unencrypted second unicast beacons, (3) encrypting the unencrypted second unicast beacons to obtain encrypted second unicast beacons, and (4) wirelessly transmitting the encrypted second unicast beacons to the second client of the IEEE 802.11 wireless communication network.
(A9) In the method denoted as (A8), (1) encrypting the unencrypted first unicast beacons to obtain encrypted first unicast beacons may include encrypting the unencrypted first unicast beacons using a first pairwise transient key (PTK) associated with the first client of the IEEE 802.11 wireless communication network, (2) encrypting the unencrypted second unicast beacons to obtain encrypted second unicast beacons may include encrypting the unencrypted second unicast beacons using a second PTK associated with the second client of the IEEE 802.11 wireless communication network, and (3) the second PTK may be different from the first PTK.
(B1) A method operable by a wireless access point for managing beacons in an Institute of Electrical and Electronics Engineers (IEEE) 802.11 wireless communication network includes (1) generating unencrypted first broadcast beacons, the unencrypted first broadcast beacons including a first Basic Service Set IDentifier (BSSID) identifying a first basic service set (BSS), (2) wirelessly transmitting the unencrypted first broadcast beacons to at least a first client of the IEEE 802.11 wireless communication network, (3) determining that the first client of the IEEE 802.11 wireless communication network has associated with the first BSS, (4) in response to determining that the first client of the IEEE 802.11 wireless communication network has associated with the first BSS, encrypting the unencrypted first broadcast beacons to obtain encrypted first broadcast beacons, and (5) wirelessly transmitting the encrypted first broadcast beacons to the first client of the IEEE 802.11 wireless communication network.
(B2) In the method denoted as (B1), encrypting the unencrypted first broadcast beacons to obtain encrypted first broadcast beacons may include encrypting the unencrypted first broadcast beacons using a pairwise transient key (PTK) associated with the first client of the IEEE 802.11 wireless communication network.
(B3) Either one of the methods denoted as (B1) and (B2) may further include exchanging a key with the first client of the IEEE 802.11 wireless communication network to enable the first client to decrypt the encrypted first broadcast beacons.
(B4) In any one of the methods denoted as (B1) through (B3), a second client of the IEEE 802.11 wireless communication network may be unable to decrypt the encrypted first broadcast beacons.
(B5) In any one of the methods denoted as (B1) through (B4), the encrypted first broadcast beacons may include the first BSSID.
(B6) In any one of the methods denoted as (B1) through (B5), at least one of the encrypted first broadcast beacons may include a channel switch announcement.
(B7) In any one of the methods denoted as (B1) through (B6), the first BSS may be a virtual basic service set.
(B8) The method denoted as (B1) may further include (1) determining that a second client of the IEEE 802.11 wireless communication network has associated with a second BSS, (2) in response to determining that the second client of the IEEE 802.11 wireless communication network has associated with the second BSS, encrypting unencrypted second broadcast beacons to obtain encrypted second broadcast beacons, and (3) wirelessly transmitting the encrypted second broadcast beacons to the second client of the IEEE 802.11 wireless communication network.
(B9) In the method denoted as (B8), (1) encrypting the unencrypted first broadcast beacons to obtain encrypted first broadcast beacons may include encrypting the unencrypted first broadcast beacons using a first pairwise transient key (PTK) associated with the first client of the IEEE 802.11 wireless communication network, (2) encrypting the unencrypted second broadcast beacons to obtain encrypted second broadcast beacons may include encrypting the unencrypted second broadcast beacons using a second PTK associated with the second client of the IEEE 802.11 wireless communication network, and (3) the second PTK may be different from the first PTK.
(C1) A method operable by a wireless access point for managing beacons in an Institute of Electrical and Electronics Engineers (IEEE) 802.11 wireless communication network includes (1) generating unencrypted first broadcast beacons, the unencrypted first broadcast beacons including a first Basic Service Set IDentifier (BSSID) identifying a first basic service set (BSS), (2) wirelessly transmitting the unencrypted first broadcast beacons to at least a first set of a plurality of clients, (3) determining that each client of the first set of the plurality of clients has associated with the first BSS, (4) in response to determining that each client of the first set of the plurality of clients has associated with the first BSS, encrypting the unencrypted first broadcast beacons to obtain encrypted first broadcast beacons, and (5) wirelessly transmitting the encrypted first broadcast beacons to at least the first set of the plurality of clients.
(C2) In the method denoted as (C1), a client that is served by the wireless access point but that is not part of the first set of the plurality of clients may be unable to decrypt the encrypted first broadcast beacons.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method operable by a wireless access point for managing beacons in an Institute of Electrical and Electronics Engineers (IEEE) 802.11 wireless communication network, the method comprising:
generating unencrypted first broadcast beacons, the unencrypted first broadcast beacons including a first Basic Service Set IDentifier (BSSID) identifying a first basic service set (BSS);
wirelessly transmitting the unencrypted first broadcast beacons to at least a first client of the IEEE 802.11 wireless communication network;
determining that the first client of the IEEE 802.11 wireless communication network has associated with the first BSS;
in response to determining that the first client of the IEEE 802.11 wireless communication network has associated with the first BSS, generating unencrypted first unicast beacons;
encrypting the unencrypted first unicast beacons to obtain encrypted first unicast beacons; and
wirelessly transmitting the encrypted first unicast beacons to the first client of the IEEE 802.11 wireless communication network.

2. The method of claim 1, wherein encrypting the unencrypted first unicast beacons to obtain encrypted first unicast beacons comprises encrypting the unencrypted first unicast beacons using a pairwise transient key (PTK) associated with the first client of the IEEE 802.11 wireless communication network.

3. The method of claim 1, further comprising exchanging a key with the first client of the IEEE 802.11 wireless communication network to enable the first client of the IEEE 802.11 wireless communication network to decrypt the encrypted first unicast beacons.

4. The method of claim 1, wherein a second client of the IEEE 802.11 wireless communication network is unable to decrypt the encrypted first unicast beacons.

5. The method of claim 1, wherein the encrypted first unicast beacons include the first BSSID.

6. The method of claim 1, wherein at least one of the encrypted first unicast beacons includes a channel switch announcement.

7. The method of claim 1, wherein the first BSS is a virtual BSS.

8. The method of claim 1, further comprising:
determining that a second client of the IEEE 802.11 wireless communication network has associated with a second BSS;
in response to determining that the second client of the IEEE 802.11 wireless communication network has associated with the second BSS, generating unencrypted second unicast beacons;
encrypting the unencrypted second unicast beacons to obtain encrypted second unicast beacons; and
wirelessly transmitting the encrypted second unicast beacons to the second client of the IEEE 802.11 wireless communication network.

9. The method of claim 8, wherein:
encrypting the unencrypted first unicast beacons to obtain encrypted first unicast beacons comprises encrypting the unencrypted first unicast beacons using a first pairwise transient key (PTK) associated with the first client of the IEEE 802.11 wireless communication network;
encrypting the unencrypted second unicast beacons to obtain encrypted second unicast beacons comprises encrypting the unencrypted second unicast beacons using a second PTK associated with the second client of the IEEE 802.11 wireless communication network; and
the second PTK is different from the first PTK.

10. A method operable by a wireless access point for managing beacons in an Institute of Electrical and Electronics Engineers (IEEE) 802.11 wireless communication network, the method comprising:
generating unencrypted first broadcast beacons, the unencrypted first broadcast beacons including a first Basic Service Set IDentifier (BSSID) identifying a first basic service set (BSS);
wirelessly transmitting the unencrypted first broadcast beacons to at least a first client of the IEEE 802.11 wireless communication network;
determining that the first client of the IEEE 802.11 wireless communication network has associated with the first BSS;
in response to determining that the first client of the IEEE 802.11 wireless communication network has associated with the first BSS, encrypting the unencrypted first broadcast beacons to obtain encrypted first broadcast beacons; and
wirelessly transmitting the encrypted first broadcast beacons to the first client of the IEEE 802.11 wireless communication network.

11. The method of claim 10, wherein encrypting the unencrypted first broadcast beacons to obtain encrypted first broadcast beacons comprises encrypting the unencrypted first broadcast beacons using a pairwise transient key (PTK) associated with the first client of the IEEE 802.11 wireless communication network.

12. The method of claim 10, further comprising exchanging a key with the first client of the IEEE 802.11 wireless communication network to enable the first client to decrypt the encrypted first broadcast beacons.

13. The method of claim 10, wherein a second client of the IEEE 802.11 wireless communication network is unable to decrypt the encrypted first broadcast beacons.

14. The method of claim 10, wherein the encrypted first broadcast beacons include the first BSSID.

15. The method of claim 10, wherein at least one of the encrypted first broadcast beacons includes a channel switch announcement.

16. The method of claim 10, wherein the first BSS is a virtual basic service set.

17. The method of claim 10, further comprising:
determining that a second client of the IEEE 802.11 wireless communication network has associated with a second BSS;
in response to determining that the second client of the IEEE 802.11 wireless communication network has associated with the second BSS, encrypting unencrypted second broadcast beacons to obtain encrypted second broadcast beacons; and
wirelessly transmitting the encrypted second broadcast beacons to the second client of the IEEE 802.11 wireless communication network.

18. The method of claim 17, wherein:
encrypting the unencrypted first broadcast beacons to obtain encrypted first broadcast beacons comprises encrypting the unencrypted first broadcast beacons using a first pairwise transient key (PTK) associated with the first client of the IEEE 802.11 wireless communication network;
encrypting the unencrypted second broadcast beacons to obtain encrypted second broadcast beacons comprises encrypting the unencrypted second broadcast beacons using a second PTK associated with the second client of the IEEE 802.11 wireless communication network; and
the second PTK is different from the first PTK.

19. A method operable by a wireless access point for managing beacons in an Institute of Electrical and Electronics Engineers (IEEE) 802.11 wireless communication network, the method comprising:
generating unencrypted first broadcast beacons, the unencrypted first broadcast beacons including a first Basic Service Set IDentifier (BSSID) identifying a first basic service set (BSS);
wirelessly transmitting the unencrypted first broadcast beacons to at least a first set of a plurality of clients;
determining that each client of the first set of the plurality of clients has associated with the first BSS;
in response to determining that each client of the first set of the plurality of clients has associated with the first BSS, encrypting the unencrypted first broadcast beacons to obtain encrypted first broadcast beacons; and
wirelessly transmitting the encrypted first broadcast beacons to at least the first set of the plurality of clients.

20. The method of claim 19, wherein a client that is served by the wireless access point but that is not part of the first set of the plurality of clients is unable to decrypt the encrypted first broadcast beacons.
